(19) United States
(12) Patent Application Publication
(10) Pub. No.: US 2025/0330297 A1
(43) Pub. Date: Oct. 23, 2025

(54) METHOD AND APPARATUS FOR SWITCHING DUPLEX MODE DURING RANDOM ACCESS

(71) Applicant: Samsung Electronics Co., Ltd., Suwon-si (KR)

(72) Inventors: Carmela Cozzo, San Diego, CA (US); Aristides Papasakellariou, Houston, TX (US); Marian Rudolf, Longueuil (CA)

(21) Appl. No.: 19/258,810

(22) Filed: Jul. 2, 2025

Related U.S. Application Data
(63) Continuation of application No. 17/931,877, filed on Sep. 13, 2022.
(60) Provisional application No. 63/249,377, filed on Sep. 28, 2021.

(51) Int. Cl. H04L 5/14; H04W 74/0833; H04W 74/0836

(52) U.S. Cl. CPC H04L 5/14; H04W 74/0833; H04W 74/0836

(57) ABSTRACT

Methods and apparatuses for switching duplex mode during random access (RA). A method for operating a user equipment (UE) includes receiving a system information block (SIB) for a cell that provides information for a first configuration of slots for transmissions or receptions in a half-duplex mode and a random access (RA) procedure, determining a UE capability for transmitting and receiving in a full-duplex mode, and determining a transmission of a channel based on the RA procedure and the first configuration of slots. The method further includes transmitting the channel including information of the UE capability using the RA procedure and receiving information for a second configuration of slots for transmissions or receptions in the full-duplex mode.

### CROSS-REFERENCE TO RELATED APPLICATION AND CLAIM OF PRIORITY

This application claims is a continuation of U.S. patent application Ser. No. 17/931,877, filed on Sep. 13, 2022, which claims priority under 35 U.S.C. § 119 (e) to U.S. Provisional Patent Application No. 63/249,377 filed on Sep. 28, 2021. The above-identified patent applications are hereby incorporated by reference in their entirety.

### TECHNICAL FIELD

The present disclosure relates generally to wireless communication systems and, more specifically, the present disclosure relates to switching duplex mode during random access.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to a method and an apparatus for switching duplex mode during random access.

In one embodiment, a user equipment (UE) is provided. The UE includes a transceiver configured to receive a system information block (SIB) for a cell that provides information for a first configuration of slots for transmissions or receptions in a half-duplex mode and a random access (RA) procedure. The UE further includes a processor operably coupled to the transceiver, the processor configured to determine a UE capability for transmitting and receiving in a full-duplex mode and a transmission of a channel based on the RA procedure and the first configuration of slots. The transceiver is further configured to transmit the channel including information of the UE capability using the RA procedure and receive information for a second configuration of slots for transmissions or receptions in the full-duplex mode.

In another embodiment, a base station (BS) is provided. The BS includes a transceiver configured to transmit a SIB for a cell that provides information for a first configuration of slots for receptions or transmissions in a half-duplex mode and a RA procedure; and receive, based on the RA procedure and the first configuration of slots, a channel including information of a capability of a UE. The BS further includes a processor operably coupled to the transceiver. The processor is configured to determine, based on the information, the UE capability for transmitting and receiving in a full-duplex mode. The transceiver is further configured to transmit information for a second configuration of slots for receptions or transmissions in the full-duplex mode.

In yet another embodiment, a method is provided. The method includes receiving a SIB for a cell that provides information for a first configuration of slots for transmissions or receptions in a half-duplex mode and a RA procedure, determining a UE capability for transmitting and receiving in a full-duplex mode, and determining a transmission of a channel based on the RA procedure and the first configuration of slots. The method further includes transmitting the channel including information of the UE capability using the RA procedure and receiving information for a second configuration of slots for transmissions or receptions in the full-duplex mode.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4 and 5 illustrate example wireless transmit and receive paths according to embodiments of the present disclosure;

FIG. 6 illustrates a diagram of slots according to embodiments of the present disclosure according to embodiments of the present disclosure;

FIGS. 7 and 8 illustrate example methods for UE to switch to a second operating mode based on an indication in a downlink control information (DCI) format according to embodiments of the present disclosure;

FIG. 9 illustrates an example method for a UE to switch to a Cross Division Duplex (XDD) mode for a physical uplink control channel (PUCCH) transmission in response to Msg4 physical downlink shared channel (PDSCH) according to embodiments of the present disclosure;

FIG. 10 illustrates an example method for a UE to switch to an XDD mode after completion of a 2-step RA procedure according to embodiments of the present disclosure;

FIGS. 11 and 12 illustrate example methods for a UE to switch to an XDD mode during a RA procedure according to embodiments of the present disclosure; and

FIGS. 13 and 14 illustrate example methods for a UE to switch to a second operating mode based on an indication in a DCI format according to embodiments of the present disclosure.

### DETAILED DESCRIPTION

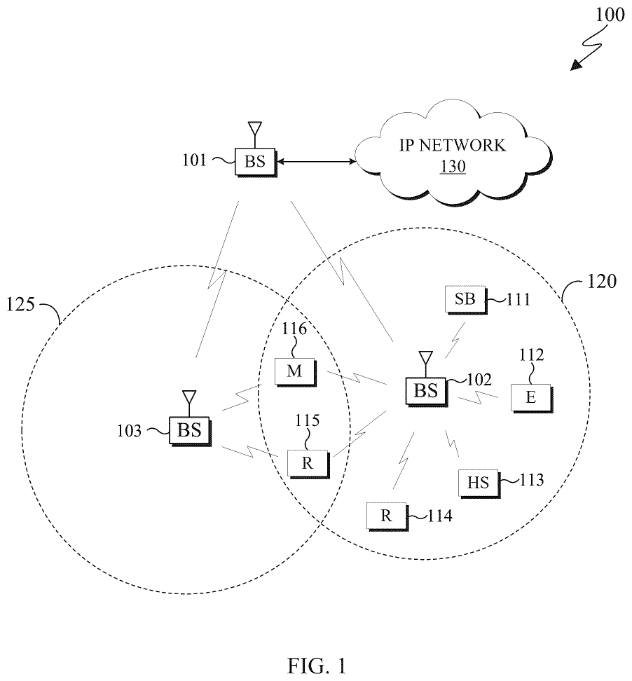

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents are hereby incorporated by reference into the present disclosure as if fully set forth herein: 3GPP TS 38.211 v17.2.0, “NR; Physical channels and modulation” (“REF1”); 3GPP TS 38.212 v17.2.0, “NR; Multiplexing and Channel coding” (“REF2”); 3GPP TS 38.213 v17.2.0, “NR; Physical Layer Procedures for Control” (“REF3”); 3GPP TS 38.214 v17.2.0, “NR; Physical Layer Procedures for Data” (“REF4”); 3GPP TS 38.321 v17.1.0, “NR; Medium Access Control (MAC) protocol specification” (“REF5”); and 3GPP TS 38.331 v17.1.0, “NR; Radio Resource Control (RRC) Protocol Specification” (“REF6”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of the fourth generation (4G) communication systems, efforts have been made to develop and deploy an improved 5th generation (5G) or pre-5G/NR communication system. Therefore, the 5G or pre-5G communication system is also called a “beyond 4G network” or a “post long term evolution (LTE) system.”

The 5G communication system is considered to be implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

Depending on the network type, the term ‘base station’ (BS) can refer to any component (or collection of components) configured to provide wireless access to a network, such as transmit point (TP), transmit-receive point (TRP), an enhanced base station (eNodeB or eNB), a gNB, a macrocell, a femtocell, a WiFi access point (AP), a satellite, or other wirelessly enabled devices. Base stations may provide wireless access in accordance with one or more wireless communication protocols, e.g., 5G 3GPP New Radio Interface/Access (NR), LTE, LTE advanced (LTE-A), High Speed Packet Access (HSPA), Wi-Fi 802.11a/b/g/n/ac, etc. The terms ‘BS,’ ‘gNB,’ and ‘TRP’ can be used interchangeably in this disclosure to refer to network infrastructure components that provide wireless access to remote terminals. Also, depending on the network type, the term ‘user equipment’ (UE) can refer to any component such as mobile station, subscriber station, remote terminal, wireless terminal, receive point, vehicle, or user device. For example, a UE could be a mobile telephone, a smartphone, a monitoring device, an alarm device, a fleet management device, an asset tracking device, an automobile, a desktop computer, an entertainment device, an infotainment device, a vending machine, an electricity meter, a water meter, a gas meter, a security device, a sensor device, an appliance, and the like.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a base station, BS 101 (e.g., gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipment's (UEs) within a coverage area 120 of the BS 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for switching duplex mode during random access. In certain embodiments, and one or more of the BSs 101-103 includes circuitry, programing, or a combination thereof for switching duplex mode during random access.

Although FIG. 1 illustrates one example of a wireless network, various changes may be made to FIG. 1. For example, the wireless network could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

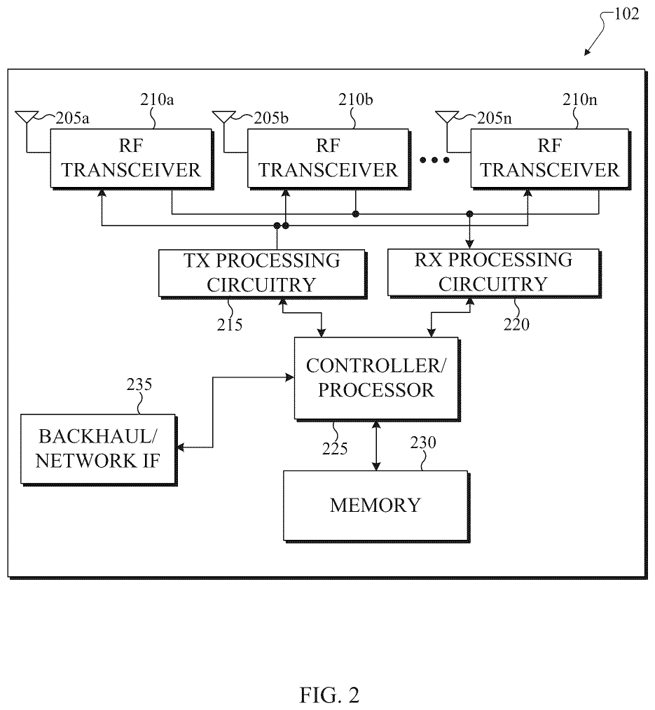

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple radio frequency (RF) transceivers 210a-210n, transmit (TX) processing circuitry 215, and receive (RX) processing circuitry 220. The BS 102 also includes a controller/processor 225, a memory 230, and a backhaul or network interface 235.

The RF transceivers 210a-210n receive, from the antennas 205a-205n, incoming RF signals, such as signals transmitted by UEs in the wireless network 100. The RF transceivers 210a-210n down-convert the incoming RF signals to generate intermediate frequency (IF) or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink channel signals and the transmission of downlink channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support switching duplex mode during random access. Any of a wide variety of other functions could be supported in the BS 102 by the controller/processor 225. In some embodiments, the controller/processor 225 includes at least one microprocessor or microcontroller.

The controller/processor 225 is also capable of executing programs and other processes resident in the memory 230, such as an OS. The controller/processor 225 can move data into or out of the memory 230 as required by an executing process. For example, the controller/processor 225 can move data into or out of the memory 230 according to a process that is being executed.

The controller/processor 225 is also coupled to the backhaul or network interface 235. The backhaul or network interface 235 allows the BS 102 to communicate with other devices or systems over a backhaul connection or over a network. The network interface 235 could support communications over any suitable wired or wireless connection(s). For example, when the BS 102 is implemented as part of a cellular communication system (such as one supporting 5G/NR, LTE, or LTE-A), the network interface 235 could allow the BS 102 to communicate with other BSs over a wired or wireless backhaul connection. When the BS 102 is implemented as an access point, the network interface 235 could allow the BS 102 to communicate over a wired or wireless local area network or over a wired or wireless connection to a larger network (such as the Internet). The network interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. As a particular example, an access point could include a number of network interfaces 235, and the controller/processor 225 could support routing functions to route data between different network addresses. As another particular example, while shown as including a single instance of TX processing circuitry 215 and a single instance of RX processing circuitry 220, the BS 102 could include multiple instances of each (such as one per RF transceiver). Also, various components in FIG. 2 could be combined, further subdivided, or omitted and additional components could be added according to particular needs.

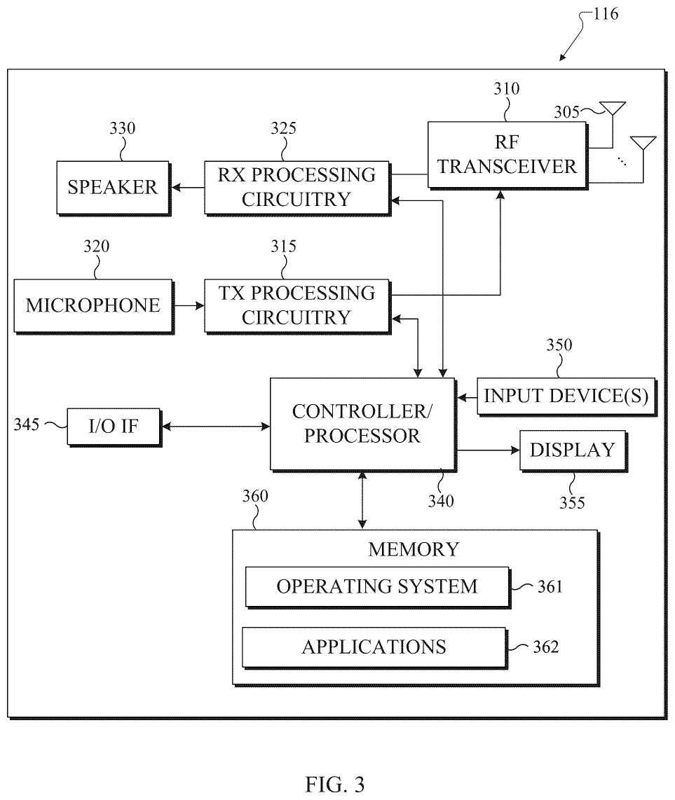

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a RF transceiver 310, TX processing circuitry 315, a microphone 320, and receive (RX) processing circuitry 325. The UE 116 also includes a speaker 330, a processor 340, an input/output (I/O) interface (IF) 345, an input device 350, a display 355, and a memory 360. The memory 360 includes an operating system (OS) 361 and one or more applications 362.

The RF transceiver 310 receives, from the antenna 305, an incoming RF signal transmitted by a BS of the wireless network 100. The RF transceiver 310 down-converts the incoming RF signal to generate an intermediate frequency (IF) or baseband signal. The IF or baseband signal is sent to the RX processing circuitry 325 that generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of uplink channel signals and the transmission of downlink channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for beam management. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input device 350. The operator of the UE 116 can use the input device 350 to enter data into the UE 116. The input device 350 can be a keyboard, touchscreen, mouse, track ball, voice input, or other device capable of acting as a user interface to allow a user in interact with the UE 116. For example, the input device 350 can include voice recognition processing, thereby allowing a user to input a voice command. In another example, the input device 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme.

The processor 340 is also coupled to the display 355. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

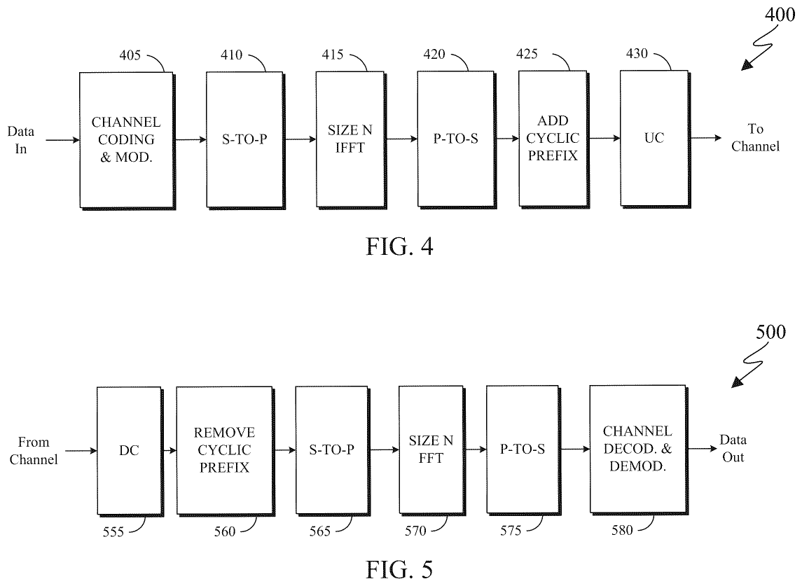

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support switching duplex mode during random access as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A 4-step RA procedure, also known as a Type-1 (L1) random access procedure, includes (i) the transmission of a physical random access channel (PRACH) preamble (Msg1) by a UE (denoted as step-1), (ii) an attempt by the UE to receive a random access response (RAR) (or Msg2) (stated differently, a BS (such as the BS 102) transmission of RAR message with a physical downlink control channel (PDCCH)/physical downlink shared channel (PDSCH) (Msg2)) (denoted as step-2), (iii) the transmission of a contention resolution message (Msg3) physical uplink shared channel (PUSCH) by the UE and when applicable, the transmission of a PUSCH scheduled by a RAR uplink (UL) grant (denoted as step-3), and (iv) the attempt by the UE to receive a contention resolution message (Msg4) (stated differently, BS transmission of a contention resolution message) (denoted as step-4).

Instead of a 4-step RA procedure, a 2-step RA procedure, also known as Type-1 (L1) random access procedure, can be used where a UE can transmit both a PRACH preamble and a PUSCH (MsgA) prior to reception of a corresponding RAR (MsgB).

A slot format includes downlink symbols, uplink symbols, and flexible symbols. If a UE is provided tdd-UL-DL-ConfigurationCommon, the UE sets the slot format per slot over a number of slots as indicated by tdd-UL-DL-ConfigurationCommon. The tdd-UL-DL-ConfigurationCommon provides a reference sub-carrier spacing (SCS) configuration μ_{ref} and a pattern1. The pattern1 provides a slot configuration period P associated to a reference SCS configuration, wherein the slot configuration period of P ms includes s=P·2^{μ}^{_{ref}} slots with SCS configuration μ_{ref}, a number of downlink slots, a number of downlink symbols d_{sym}, a number of uplink slots μₛₗₒₜₛ and a number of uplink symbols μ_{sys}. In a slot configuration period p there are S slots, of which the first dₛₗₒₜₛ slots are downlink and the last μₛₗₒₜₛ are uplink. The symbols after the d_{sym} downlink symbols after the dₛₗₒₜₛ slots and before the μ_{sym} symbols before the u slots are flexible symbols. When configured with tdd-UL-DL-ConfigurationCommon, the UE may be provided with 2 patterns pattern1 and pattern2 with slot configuration periods P1 and P2 respectively. The periods P1 and P2 may be different, but the UE expects that P1+P2 divides 20 ms. Each period includes a number of slots If configured with 2 patterns, the UE sets the slot format per slot over a first number of slots as indicated by pattern1 and the UE sets the slot format per slot over a second number of slots as indicated by pattern2. The flexible symbols are determined for each pattern from the downlink and uplink slots and the downlink and uplink symbols of each pattern. A given pattern provided by tdd-UL-DL-ConfigurationCommon only allows for a single downlink (DL)-UL switching point per slot configuration period. The use of 2 patterns allows to configure 2 such switching points and therefore adds flexibility to DL-UL slot assignments.

If the UE (such as the UE 116) is additionally provided tdd-UL-DL-ConfigurationDedicated, the parameter tdd-UL-DL-ConfigurationDedicated overrides only flexible symbols per slot over the number of slots as provided by tdd-UL-DL-ConfigurationCommon. A slot configuration period and a number of downlink symbols, uplink symbols, and flexible symbols in each slot of the slot configuration period are determined from tdd-UL-DL-ConfigurationCommon and tdd-UL-DL-ConfigurationDedicated and are common to each configured bandwidth part (BWP). A UE considers symbols in a slot indicated as downlink by tdd-UL-DL-ConfigurationCommon, or tdd-UL-DL-ConfigurationDedicated to be available for receptions and considers symbols in a slot indicated as uplink by tdd-UL-DL-ConfigurationCommon, or by tdd-UL-DL-ConfigurationDedicated to be available for transmissions.

An NR time division duplexing (TDD) component carrier (CC) is a single carrier which uses the same frequency band for the uplink and the downlink. TDD has a number of advantages over frequency division duplexing (FDD). For example, use of the same band for DL and UL transmissions leads to simpler UE implementation with TDD because a duplexer is not required. Another advantage is that time resources can be flexibly assigned to UL and DL considering an asymmetric ratio of traffic in both directions, DL is typically assigned most time resources in TDD to handle DL-heavy mobile traffic. Another advantage is that channel state information (CSI) can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the usually small portion of time resources available for UL transmissions, while with FDD all time resources can be used for UL transmissions. Another disadvantage is latency. In TDD, a timing gap between DL reception and UL transmission containing the hybrid automatic repeat request (HARQ) acknowledgement (ACK) information associated with DL receptions is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a physical uplink control channel (PUCCH) providing HARQ-ACK information needs to be transmitted with repetitions in order to improve coverage (an alternative in such case is for a network to forgo HARQ-ACK information at least for some transport blocks in the DL).

To address some of the disadvantages for TDD operation, a dynamic adaptation of link direction has been considered where, with the exception of some symbols in some slots supporting predetermined transmissions such as for synchronization signal (SS) physical broadcast channel (PBCH) (SS/PBCH Block (SSBs)), symbols of a slot can have a flexible direction (UL or DL) that a UE can determine according to scheduling information for transmissions or receptions. A PDCCH can also be used to provide a downlink control information (DCI) format, such as a DCI format 2_0 as described in REF 3, that can indicate a link direction of some flexible symbols in one or more slots. Nevertheless, in actual deployments, it is difficult for a gNB scheduler to adapt a transmission direction of symbols without coordination with other gNB schedulers in the network. This is because of cross-link interference (CLI) where, for example, DL receptions in a cell by a UE can experience large interference from UL transmissions in the same or neighboring cells from other UEs.

Full-duplex (FD) communications offer a potential for increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a full-duplex wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused or only respective subsets can be active for transmissions and receptions when FD communication is enabled.

Instead of using a single carrier, it is also possible to use different CCs for receptions and transmissions by a UE. For example, receptions by a UE can occur on a first CC and transmissions by the UB occur on a second CC having a small, including zero, frequency separation from the first CC.

Furthermore, a gNB (such as BS 102) can operate with full-duplex mode even when a UE still operates in half-duplex mode, such as when the UE can either transmit or receive at a same time, or the UE can also be capable for full-duplex operation.

Full-duplex transmission/reception is not limited to gNBs, TRPs, or UEs, but can also be used for other types of wireless nodes such as relay or repeater nodes.

Full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Full-duplex operation in NR can improve spectral efficiency, link robustness, capacity, and latency of UL transmissions. In an NR TDD system, UL transmissions are limited by fewer available transmission opportunities than DL receptions. For example, for NR TDD with SCS=30 KHz, DDDU (2 msec), DDDSU (2.5 msec), or DDDDDDDSUU (5 msec), the UL-DL configurations allow for an DL:UL ratio from 3:1 to 4:1. Any UL transmission can only occur in a limited number of UL slots, for example every 2, 2.5, or 5 msec, respectively.

Throughout the disclosure, a UE (such as the UE 116) operating in FD or half-duplex (HD) mode is also referred as a Cross Division Duplex (XDD) UE. The terms “full-duplex”, “half-duplex” and “XDD” are used interchangeably in this disclosure to refer to simultaneous DL and UL operation within a TDD carrier by using different TDD configurations across different frequency regions of a BWP, or across different sub-bands of one or more BWP, or also different frequency regions of different BWPs, wherein a frequency region can comprise part or all of the subcarriers of a BWP.

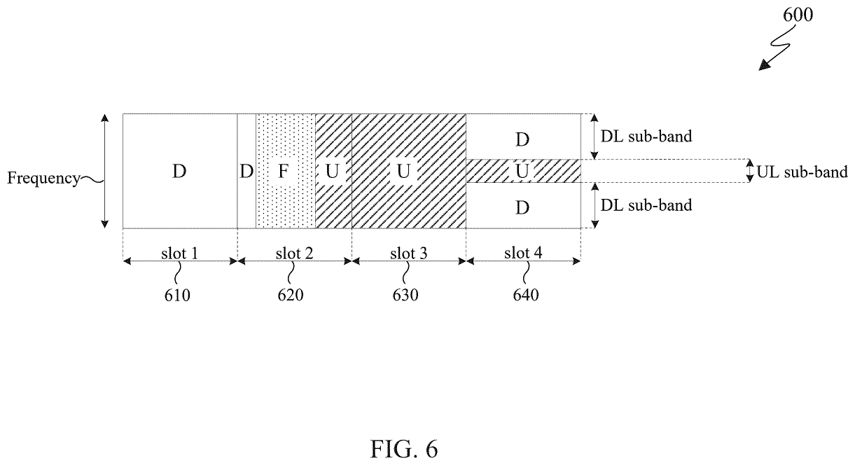

FIG. 6 illustrates a diagram 600 of slots according to embodiments of the present disclosure according to embodiments of the present disclosure. FIG. 6 is for illustration only and other embodiments can be used without departing from the scope of the present disclosure. Although FIG. 6 illustrates an example slot configuration, various changes may be made to FIG. 6.

In certain embodiments, when a UE (such as the UE 116) operates in TDD mode and is provided a TDD UL-DL configuration, a slot can be a downlink slot with all downlink symbols, or an uplink slots with all uplink symbols, or a slot with downlink, and/or flexible symbols, and/or uplink symbols. As illustrated in FIG. 6, a slot can be configured with all downlink symbols 610, or with downlink symbols, flexible symbols and uplink symbols 620, or with all uplink symbols 630, wherein each symbol comprises any of the frequency resources in a configured BWP. When a UE operates in XDD mode, a slot can be also configured with sub-bands of a BWP 640, wherein each symbol of the slot can be either a DL symbol in the DL sub-band or an UL symbol in the UL sub-band. The slot where there is at least one sub-band for UL and one sub-band for DL is called an X slot. One or more sub-bands for uplink and one or more sub-bands for downlink can occupy different parts of a BWP. For example, a sub-band for uplink can occupy the middle portion of the BWP and the downlink sub-bands can occupy the lower and higher parts of a BWP. Uplink and downlink sub-bands can have different sizes.

As used herein, an operation in non-XDD mode refers to a UE that is configured an UL-DL TDD slot format configuration and can transmit/receive a symbol in any of the frequency resources of active UL/DL BWPs; and an operation in XDD mode refers to a UE that is configured an XDD slot format configuration that can include UL, DL or XDD slots.

A UE can operate in XDD mode during connected mode and/or initial access or for some steps of a random access (RA) procedure. While a RA procedure in non-XDD mode allows sharing of time and frequency resources among XDD and non-XDD UEs in a cell and reduces system resource fragmentation, operating some or all steps of the RA procedure in XDD mode has the advantage of flexible resource allocation and optimization of UE-specific signaling by allowing simultaneous UL and DL transmissions in different frequency regions or sub-bands of a BWP.

A UE can also operate in XDD mode with different configurations in different time periods. An adaptation over time of an XDD configuration is helpful to mitigate the interference level in a cell and enhance scheduling flexibility. Different sub-bands of a BWP and/or different BWPs, or also different CCs, can be configured for UL or DL in different time periods depending on the load in the cell and on UE capabilities to operate in FD, HD or XDD mode.

Accordingly, embodiments of the present disclosure relate to a duplex mode operation during a RA procedure, and to operating with a duplex technique for some or all steps of the RA procedure. Embodiments of the present disclosure also relate to a UE determining a duplex mode for a step of a RA procedure. Embodiments of the present disclosure further relate to the UE determining a timing to switch to a duplex mode operation. Additionally, embodiments of the present disclosure relate to an early UE identification in Msg3 of a UE capability of operating in a duplex mode.

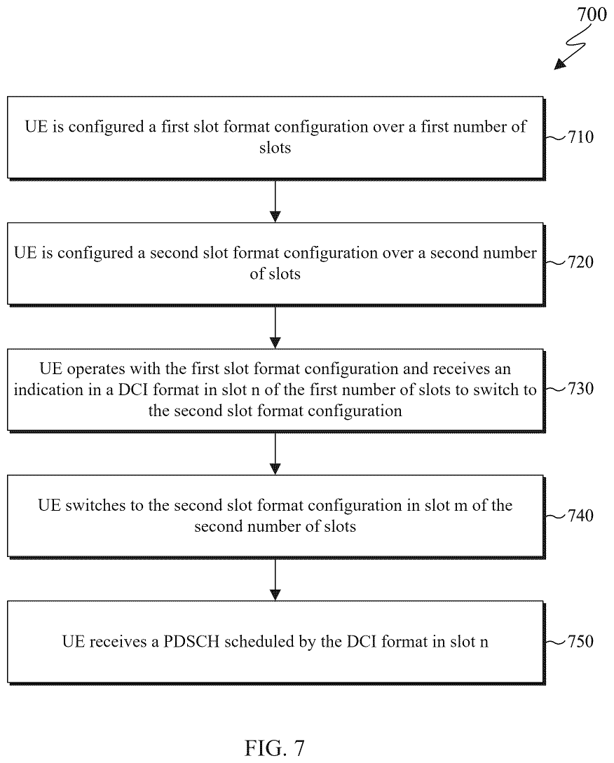

Embodiments of the present disclosure describe TDD operations during RA and switching to XDD operations for connected mode. This is described in the following examples and embodiments, such as those of FIGS. 7-10.

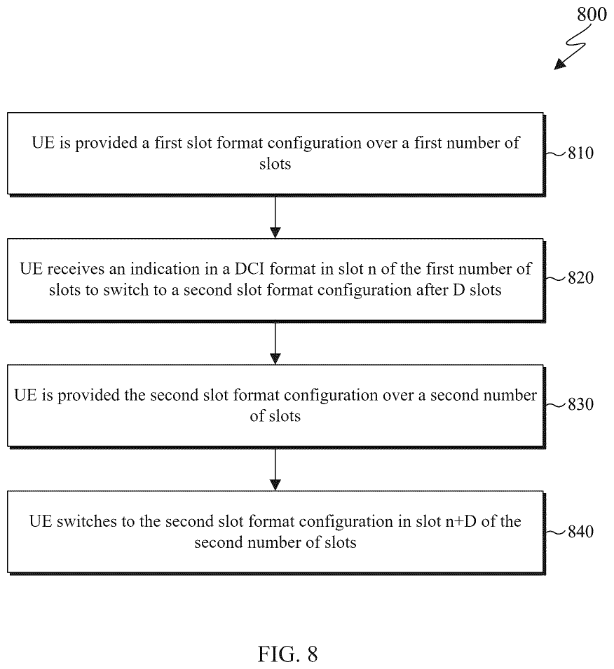

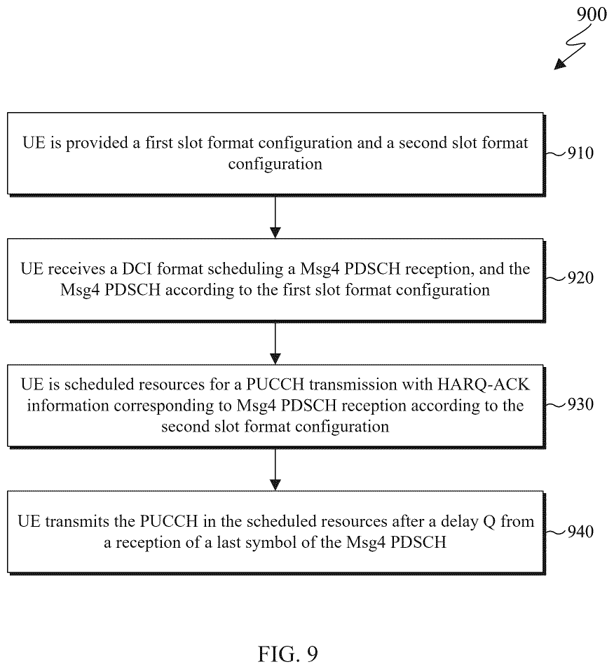

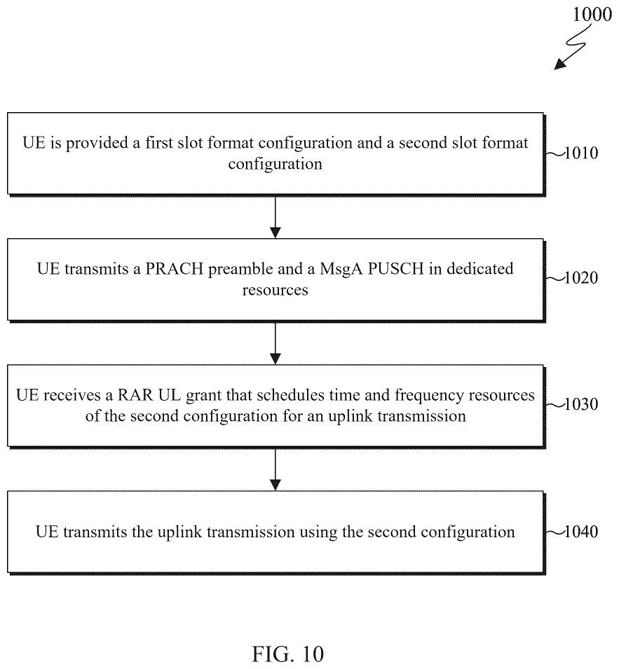

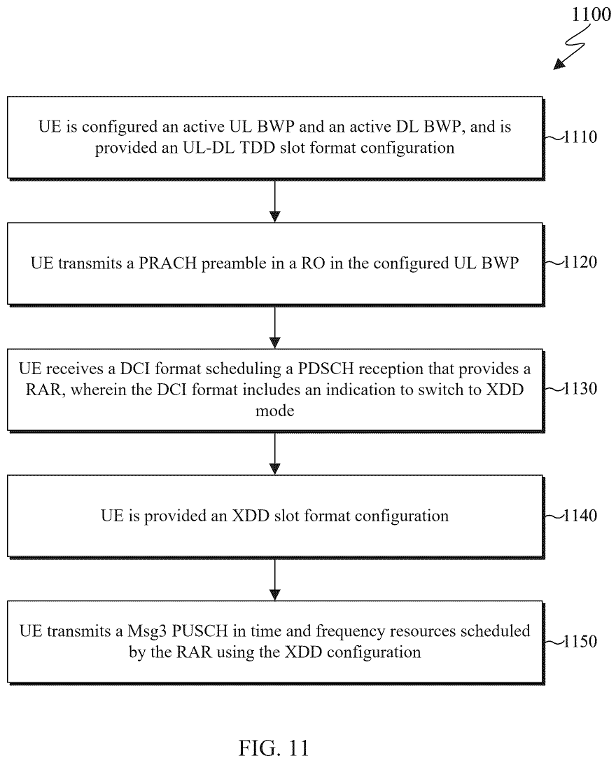

FIGS. 7 and 8 illustrate example methods 700 and 800, respectively for UE to switch to a second operating mode based on an indication in a DCI format according to embodiments of the present disclosure. FIG. 9 illustrates an example method 900 for a UE to switch to a XDD mode for a PUCCH transmission in response to Msg4 PDSCH according to embodiments of the present disclosure. FIG. 10 illustrates an example method 1000 for a UE to switch to an XDD mode after completion of a 2-step RA procedure according to embodiments of the present disclosure.

The steps of the method 700 of FIG. 7, the method 800 of FIG. 8, the method 900 of FIG. 9, and the method 1000 of FIG. 10 can be performed by any of the UEs 111-116 of FIG. 1, such as the UE 116 of FIG. 3. The methods 700-1000 are for illustration only and other embodiments can be used without departing from the scope of the present disclosure.

In certain embodiments, a UE (such as the UE 116) is configured to operate in TDD mode, and for each symbol all frequency resources of an UL BWP and a DL BWP are configured as UL, DL or flexible by tdd-UL-DL-ConfigurationCommon and, if additionally provided, by tdd-UL-DL-ConfigurationDedicated. The UE transmits a PRACH preamble in a PRACH Occasion (RO) in an active UL BWP and may receive a RAR in an active DL BWP, wherein the UL and DL BWPs are the initial UL and DL BWPs configured by higher layers or other UL and DL BWPs configured by higher layers. Upon reception of a RAR message, the UE transmits a Msg3 PUSCH in an active UL BWP and receives a Msg4 PDSCH in an active DL BWP, respectively. In response to PDSCH reception that includes information for contention resolution, such as a UE identity, the UE transmits HARQ-ACK information in a PUCCH. The UE can be additionally configured to operate in XDD mode during connected mode and is provided a slot format configuration that configures slots as UL, DL or X slots. The UE can switch from TDD mode to XDD mode operation and transmit the PUCCH including the HARQ-ACK information corresponding to the Msg4 PDSCH in XDD mode. Depending on the slot format configuration and scheduling information provided in Msg4 PDSCH, the transmission of the PUCCH can be in an UL slot and/or an X slot. When the PUCCH is transmitted in an X slot, the UL BWP of the PUCCH transmission can be same or different than the UL BWP of the Msg3 PUSCH transmission. For example, the Msg3 PUSCH is transmitted in a first UL BWP and the PUCCH is transmitted in a sub-band of a first DL BWP that is configured for UL in XDD mode. It is also possible that the PUCCH is transmitted in a sub-band of the first UL BWP that includes at least another sub-band that is configured for DL when in XDD mode. A minimum time between the last symbol of a Msg4 PDSCH reception and a first symbol of the corresponding PUCCH transmission with the HARQ-ACK information is equal to Q=N_{T,1}+0.5+N_{bwp} msec. N_{T,1} is a time duration of symbols corresponding to a PDSCH processing time for UE processing capability 1 when PDSCH DM-RS is configured. N_{bwp} is an additional delay due to the BWP switching and can be larger than zero when Msg3 PUSCH and PUCCH corresponding to Msg4 PDSCH are transmitted in different BWPs. The different BWPs can be BWPs of a same carrier or different carriers.

When a UE (such as the UE 116) is provided a TDD UL-DL slot format configuration and performs a RA procedure in TDD mode, and is additionally provided an XDD slot format configuration, the UE can switch from TDD mode to XDD mode starting from a transmission of a PUCCH including the HARQ-ACK information corresponding to a Msg4 PDSCH, wherein a Msg4 PDSCH reception indicates to switch to XDD mode. It is also possible that the UE transmits the PUCCH in response to the Msg4 PDSCH in TDD mode, and switches to XDD mode for transmission of a scheduled or configured PUSCH or PUCCH transmission after a positive HARQ-ACK information corresponding to the Msg4 PDSCH is received by a gNB, wherein a reception of the scheduling information indicates to switch to XDD mode.

When a UE (such as the UE 116) is configured with a 2-step RA, the UE can switch from TDD mode to XDD mode operation after receiving the RAR. For contention based random access (CBRA), if contention resolution is not successful, a fallback indication is received in MsgB, and the UE performs Msg3 transmission using the UL grant included in the fallback indication in MsgB and monitors contention resolution in TDD mode. Similar to the 4-step RA procedure, the UE can switch from TDD mode to XDD mode starting from the transmission of a PUCCH including the HARQ-ACK information corresponding to a first PDSCH reception that includes information for contention resolution, or switches to XDD mode for transmission of a scheduled or configured PUSCH or PUCCH transmission after a positive HARQ-ACK corresponding to the first PDSCH is received by a gNB (i.e. after the UE transmits the PUCCH providing an ACK value).

A switch from an operating mode, such as TDD mode, to another operating mode, such as XDD, can be based on an indication in a DCI format and the timing relationship between a reception of a DCI format and an uplink transmission of a scheduled or configured transmission, can be fixed, or configured, or indicated by the DCI format that provides the information to switch. Alternatively, or additionally, for a UE operating in a first duplex mode, upon reception of the indication in the DCI format to operate in a second duplex mode, the UE is provided a slot format configuration of the second duplex mode.

The method 700, as illustrated in FIG. 7, describes an exemplary procedure where the UE switches to a second operating mode based on an indication in a DCI format.

In step 710, a UE (such as the UE 116) is configured a first slot format configuration over a first number of slots. In step 720, the UE is configured a second slot format configuration over a second number of slots. In step 730, the UE operates with the first slot format configuration and receives an indication in a DCI format in slot n of the first number of slots to switch to the second slot format configuration. In step 740, the UE switches to the second slot format configuration in slot m of the second number of slots. In step 750, the UE receives a PDSCH scheduled by the DCI format in slot n.

The method 800, as illustrated in FIG. 8, describes an exemplary procedure where the UE switches to a second operating mode based on an indication in a DCI format.

In step 810, a UE (such as the UE 116) is provided a first slot format configuration over a first number of slots. In step 820, the UE receives an indication in a DCI format in slot n of the first number of slots to switch to a second slot format configuration after D slots. In step 830, the UE is provided the second slot format configuration over a second number of slots. In step 840, the UE switches to the second slot format configuration in slot n+D of the second number of slots.

The method 900, as illustrated in FIG. 9, describes an exemplary procedure where the UE switches to XDD mode for a PUCCH transmission in response to Msg4 PDSCH.

In step 910, a UE (such as the UE 116) is provided a first slot format configuration and a second slot format configuration, for example in a system information block (SIB). The first configuration is a TDD configuration and the second configuration is a XDD configuration. In step 920, the UE receives a DCI format scheduling a Msg4 PDSCH reception, and the Msg4 PDSCH according to the first slot format configuration. For example, the UE can provide an indication for a capability to operate with XDD slots in the Msg3 transmission. In step 930, the UE is scheduled resources for a PUCCH transmission with HARQ-ACK information corresponding to Msg4 PDSCH reception according to the second slot format configuration. In step 940, the UE transmits the PUCCH in the scheduled resources after a delay Q from a reception of a last symbol of the Msg4 PDSCH.

The method 1000, as illustrated in FIG. 10, describes an exemplary procedure where the UE switches to XDD mode after completion of a 2-step RA procedure.

In step 1010, a UE (such as the UE 116) is provided a first slot format configuration and a second slot format configuration, for example in a SIB. Here, the first configuration is a TDD configuration and the second configuration is a XDD configuration. In step 1020, the UE transmits a PRACH preamble and a MsgA PUSCH in dedicated resources. For example, the UE can provide an indication for a capability to operate with XDD slots in the MsgA transmission. In step 1030, the UE receives a RAR UL grant that schedules time and frequency resources of the second configuration for an uplink transmission. In step 1040, the UE transmits the uplink transmission using the second configuration.

Although FIG. 7 illustrates the method 700, FIG. 8 illustrates the method 800, FIG. 9 illustrates the method 900, and FIG. 10 illustrates the method 1000 various changes may be made to FIGS. 7-10. For example, while the methods 700-1000 are shown as a series of steps, various steps could overlap, occur in parallel, occur in a different order, or occur multiple times. In another example, steps may be omitted or replaced by other steps. For example, steps of the method 700, the method 800, the method 900, and the method 1000 can be executed in a different order.

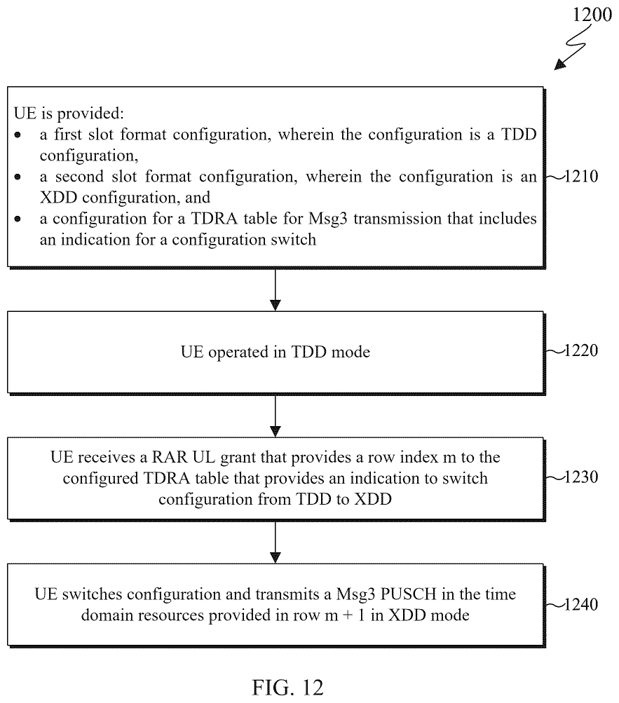

Embodiments of the present disclosure describe XDD operations during RA. This is described in the following examples and embodiments, such as those of FIGS. 11 and 12.

FIGS. 11 and 12 illustrate example methods 1100 and 1200, respectively, for a UE to switch to an XDD mode during a RA procedure according to embodiments of the present disclosure. The steps of the method 1100 of FIG. 11 and the method 1200 of FIG. 12 can be performed by any of the UEs 111-116 of FIG. 1, such as the UE 116 of FIG. 3. The methods 1100 and 1200 are for illustration only and other embodiments can be used without departing from the scope of the present disclosure.

In certain embodiments, a UE (such as the UE 116) can be configured for XDD operation for a RA procedure. The UE can be scheduled to transmit in frequency resources of an active UL BWP or in frequency resources of a sub-band of an active DL BWP configured for UL for one or more of the steps of the RA procedure. When more than one UL and/or DL BWPs are active, scheduling restrictions can apply to the one or more active BWPs and can affect different sub-bands in different active BWPs. The following embodiments are described for a UE with an active UL BWP and an active DL BWP and apply also when a UE is configured multiple active UL BWPs and/or multiple active DL BWPs.

In one embodiment, a UE (such as the UE 116) is configured for XDD operation for some of the steps of the RA procedure. For example, the UE can transmit Msg1 and receive Msg2 in TDD mode, and then switch to XDD mode for Msg3 transmission. For example, based on a selection of the PRACH preamble used for Msg1 transmission, the UE can indicate a capability to operate in XDD slots. The UE can switch from TDD mode to XDD mode based on an indication in a DCI format scheduling a PDSCH reception providing a RAR message corresponding to a Msg3 PUSCH transmission. A UE transmits a PRACH preamble in a RO and receives the DCI format with cyclic redundancy check (CRC) scrambled by a corresponding RA-radio network temporary identifier (RNTI) in a DL BWP and the PDSCH scheduling the Msg3 PUSCH transmission in the DL BWP, and then switches to XDD mode for the Msg3 PUSCH transmission. The indication in DCI can be a 1-bit field that can be set to “1” to indicate to switch to XDD mode, or to “0” otherwise.

In another embodiment, in a 4-step RA procedure a UE switches from TDD mode to XDD mode based on an indication by a field in an UL grant of a RAR message scheduling a Msg3 PUSCH transmission and transmits Msg3 PUSCH transmission in XDD mode. It is also possible that the indication for switching operating mode is received during a 2-step RA procedure in UL grant included in the fallback indication in MsgB.

In another embodiment, an indication to operate in XDD mode for transmission of a Msg3 PUSCH can be in a field of a time domain resource allocation (TDRA) table. For example, a field of 1-bit can indicate whether or not the UE operates in XDD mode starting from the Msg3 PUSCH transmission or can indicate whether the UE operates in XDD mode starting from the Msg3 PUSCH transmission or from a PUCCH transmission in response to a reception of Msg4 PDSCH. The TDRA table that includes the field for XDD operation can be the default table or can be an additional TDRA table configured by the gNB, and other fields in the additional TDRA table can be same as in the default TDRA table.

In yet another embodiment, one bit of a transmit power control (TPC) command can be used as an indication to operate in XDD mode for transmission of a Msg3 PUSCH. For a UE that has been identified for operation in XDD mode, TPC command in the lower range of values (negative values) are less likely to be used and the number of indicated TPC values can be reduced by using one bit to indicate the operation in XDD mode.

The method 1100, as illustrated in FIG. 11, describes an exemplary procedure where the UE switches to XDD mode during a RA procedure based on an indication in a DCI format scheduling a RAR message according to the disclosure.

In step 1110, a UE (such as the UE 116) is configured an active UL BWP and an active DL BWP and is provided an UL-DL TDD slot format configuration. In step 1120, the UE transmits a PRACH preamble in a RO in the configured UL BWP. In step 1130, the UE receives a DCI format scheduling a PDSCH reception that provides a RAR. Herein the DCI format includes an indication to switch to XDD mode. In step 1140, the UE is provided an XDD slot format configuration. In step 1150, the UE transmits a Msg3 PUSCH in time and frequency resources scheduled by the RAR using the XDD configuration.

The method 1200, as illustrated in FIG. 12, describes an exemplary procedure where the UE switches to XDD mode during a RA procedure based on an indication in a RAR message.

In step 1210, a UE (such as the UE 116) is provided: a first slot format configuration, a second slot format configuration and a configuration for a TDRA table for Msg3 transmission that includes an indication for a configuration switch. Here, the first slot format configuration is a TDD configuration and the second slot format configuration is an XDD configuration. For example, the information can be provided by a SIB. In step 1220, the UE operates in TDD mode. In step 1230, the UE receives a RAR UL grant that provides a row index m to the configured TDRA table that provides an indication to switch configuration from TDD to XDD. In step 1240, the UE switches configuration and transmits a Msg3 PUSCH in the time domain resources provided in row m+1 in XDD mode.

In certain embodiments, the PDCCH order initiating random access configures the UE for random access transmissions for one, some or all of the steps of the RA procedure. A PDCCH order associated with configuration of the access mode, e.g., TDD mode or XDD mode, can use a CRC of the DCI format 1_0 scrambled by cell-RNTI (C-RNTI) and the “frequency domain resource assignment” field are of all ones. Alternatively, another DCI format, combination of codepoints and/or IE settings in DCI format 1_0 can be used to indicate the PDCCH order and distinguish it from the payload format used for DL scheduling. The PDCCH order can carry an indication of which of the step(s) of the RA procedure are to be executed using TDD and/or XDD mode including their associated configurations. The indication may comprise one or multiple bits. Associated bit settings and/or codepoints may request from the UE to transmit RACH Msg1 or MsgA using TDD or XDD radio resources or may request from the UE to receive the RACH Msg2 or MsgB using TDD or XDD radio resources. A first indication may request the use of TDD mode for RACH Msg1/MsgA or preamble transmission using TDD resources, e.g., normal UL slots, while a second indication may request the use of XDD resources for purpose of Msg3 PUSCH transmission as described in other embodiments of the disclosure, e.g., as described for the case of the RAR message scheduling Msg3 PUSCH.

In certain embodiments, a UE switches from/to TDD mode to XDD mode based on an indication by one or a combination of fields in a PDCCH order requesting random by determining a value of the Random Access Preamble index field, SS/PBCH index field, PRACH Mask index field, the UL/SUL indicator field, or the Reserved bits. A first set of index values may be associated with transmission in TDD resources, e.g., normal UL slots, but a second set of index values is associated with transmission in XDD resources. For example, ra-PreambleIndex may indicate a first and a second set of preamble index values associated with TDD or XDD transmissions. A transmission or reception timing indication as described in other embodiments of the disclosure may be included.

For example, the SS/PBCH index field of the PDCCH order may indicate to the UE which transmission configuration to use, e.g., TDD or XDD mode. When the value of the Random Access Preamble index field is not all zeros, the SS/PBCH index field is used for purpose of signaling the TDD or XDD transmission configuration. Out of the 6 bits in this field, a first bit is used to signal if the RACH preamble transmission is to use TDD or XDD mode, a second bit indicates if RACH Msg3 is to use TDD or XDD mode. One or more bits to switch between a first and a second available or configured XDD transmission configuration may be included. Alternatively, reserved bits, e.g., 10 bits when not operating in a cell with shared spectrum channel access may be used by the UE to determine the TDD or XDD transmission configuration and/or switching command as described in the case of the SS/PBCH index field.

One motivation for the use of the PDCCH order to (re-)configure the UE for purpose of random access using TDD or XDD mode and associated configuration is service continuity during operation in RRC_CONNECTED state. For example, re-establishment of UL synchronization on the serving cell or during handover are two possible trigger/purposes for the use of PDCCH orders. The network will dynamically adjust full-duplex transmissions in the cell to operating conditions such as admissible UE pairings and transmit/receive power levels. The possibility to indicate the use of TDD or XDD mode and associated configuration(s) to UEs with the PDCCH order allows network-initiated random access even in RRC_CONNECTED mode when some of the UEs are not temporarily reachable, e.g., like in the case of loss of UL sync.

Although FIG. 11 illustrates the method 1100 and FIG. 12 illustrates the method 1200 various changes may be made to FIGS. 11 and 12. For example, while the methods 1100 and 1200 are shown as a series of steps, various steps could overlap, occur in parallel, occur in a different order, or occur multiple times. In another example, steps may be omitted or replaced by other steps. For example, steps of the method 1100 and the method 1200 can be executed in a different order.

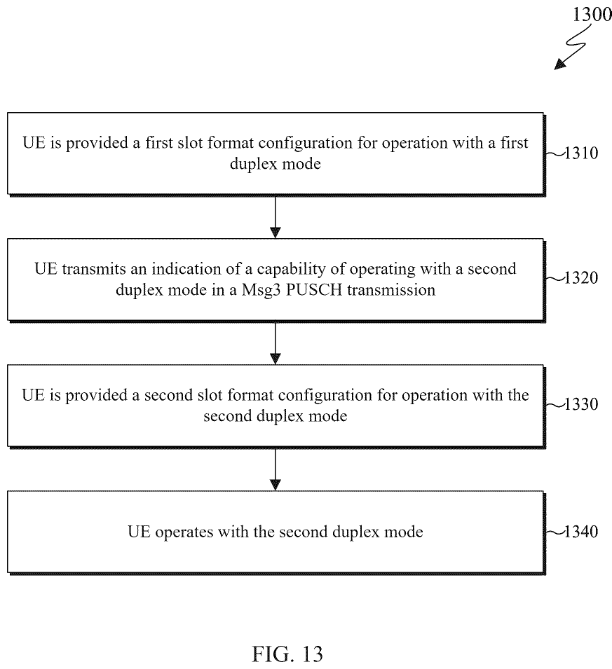

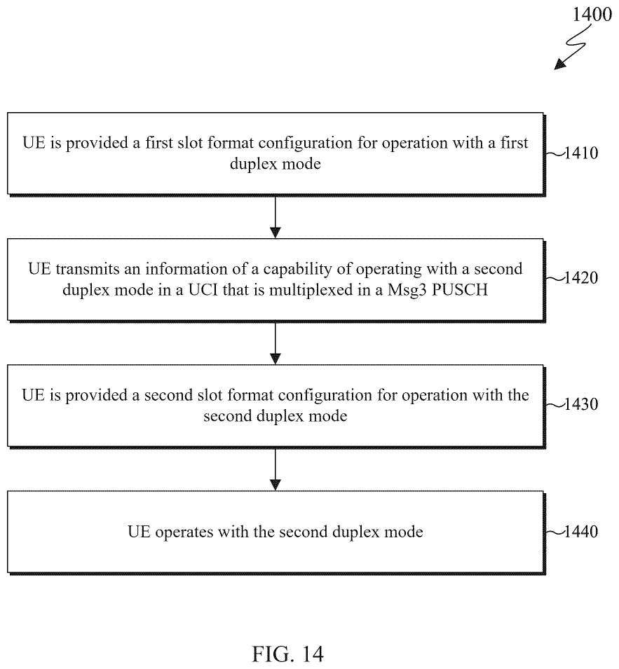

Embodiments of the present disclosure further describe early indication in Msg3 PUSCH of UE capability of XDD mode operation. This is described in the following examples and embodiments, such as those of FIGS. 13 and 14.

FIGS. 13 and 14 illustrate example methods 1300 and 1400, respectively for a UE to switch to a second operating mode based on an indication in a DCI format according to embodiments of the present disclosure. The steps of the method 1300 of FIG. 13 and the method 1400 of FIG. 14 can be performed by any of the UEs 111-116 of FIG. 1, such as the UE 116 of FIG. 3. The methods 1300 and 1400 are for illustration only and other embodiments can be used without departing from the scope of the present disclosure.

In certain embodiments, identification of UEs capable of operating in XDD mode by a gNB can be based on an indication by the UE in Msg3 PUSCH. In a 2-step RACH procedure, the UE indicates its capability of operating in XDD mode in MsgA PUSCH. One advantage of identifying a UE supporting XDD mode in Msg3 PUSCH is when Msg1 identification, for example by partitioning of PRACH preambles and/or ROs, is not configured to avoid PRACH resources fragmentation. A UE indication in Msg1 and/or in Msg3 that the UE is capable of operating in XDD mode can be a preference by the UE to operate in XDD mode.

In one embodiment, a field in a Msg3 PUSCH, such as a MAC control element (CE) or as multiplexed uplink control information (UCI) similar to multiplexing HARQ-ACK or CSI, can indicate whether the UE is capable of operating in XDD mode in the UL-DL BWP pair used by the UE to transmit a PRACH preamble and receive a DCI format and corresponding PDSCH including a RAR message, wherein the field in the Msg3 PUSCH can be a dedicated field or a field repurposed to indicate whether the UE can operate in XDD mode. For example, a 1-bit indication can be set to “0” to indicate that XDD mode is not supported and can be set to “1” to indicate that XDD mode is supported. It is possible that the UE is indicated in SIB multiple UL-DL BWP pairs and the UE is capable of operating in XDD mode in one or more of the indicated UL-DL BWPs. It is also possible that a bitmap in SIB indicates which of the UL-DL BWP pairs can be used for XDD mode and an indication in Msg3 PUSCH, if present, indicates one or more UL-DL BWP pairs that the UE supports in XDD mode.

For example, the UE is configured an active UL-DL BWP pair among the UL-DL BWPs indicated in SIB and starts a RA procedure in such UL-DL BWPs. In a 4-step RACH procedure, the UE operates in non-XDD mode in steps 1 to 3 by transmitting and receiving in frequency resources that can occupy any of the frequencies of the configured UL-DL BWPs and indicates its capability of operating in XDD mode in the active UL-DL BWPs in Msg3 PUSCH.

For another example, the UE indicates one of the UL-DL BWP pairs indicated in SIB where the UE is capable of operating in XDD mode. For example, if a SIB indicates 4 pairs of UL-DL BWPs, a 2-bit signaling in Msg3 PUSCH can be used. Each entry can indicate one of the UL-DL BWP pair, and absence of the 2-bit field in PUSCH indicates that XDD mode is not supported in any of the BWPs indicated in SIB. When a UE is capable of operating in any of the UL-DL BWP pairs indicated in SIB, one entry of the 2-bit signaling can indicate that the UE supports XDD mode in all BWPs. A 1-bit signaling can be used to indicate support of all or none of the BWP pairs.

After an indication in Msg3 PUSCH of the UE capability of operating in XDD mode, the UE can receive an indication to operate in XDD mode in Msg4 PDSCH. It is also possible that the UE receives the indication to operate in XDD mode after the RA procedure is complete. For example, after transmission of the PUCCH including the HARQ-ACK corresponding to Msg4 PDSCH, the UE receives in a DCI format an indication of a start of the XDD operation.

The method 1300, as illustrated in FIG. 13, describes an exemplary procedure where the UE switches to a second operating mode based on an indication in a DCI format.

In step 1310, a UE (such as the UE 116) is provided a first slot format configuration for operation with a first duplex mode. In step 1320, the UE transmits an indication of a capability of operating with a second duplex mode in a Msg3 PUSCH transmission. In step 1330, the UE is provided a second slot format configuration for operation with the second duplex mode. In step 1340, the UE operates with the second duplex mode.

The method 1400, as illustrated in FIG. 14, describes an exemplary procedure where the UE switches to a second operating mode based on an indication in a DCI format.

In step 1410, a UE (such as the UE 116) is provided a first slot format configuration for operation with a first duplex mode. In step 1420, the UE transmits an information of a capability of operating with a second duplex mode in a UCI that is multiplexed in a Msg3 PUSCH. In step 1430, the UE is provided a second slot format configuration for operation with the second duplex mode. In step 1440, the UE operates with the second duplex mode.

Although FIG. 13 illustrates the method 1300 and FIG. 14 illustrates the method 1400 various changes may be made to FIGS. 13 and 14. For example, while the methods 1300 and 1400 are shown as a series of steps, various steps could overlap, occur in parallel, occur in a different order, or occur multiple times. In another example, steps may be omitted or replaced by other steps. For example, steps of the method 1300 and the method 1400 can be executed in a different order.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to:
receive a system information block (SIB) that provides:
first information for first symbols associated only with transmissions, and
second information for second symbols associated with transmissions or receptions, and
receive a downlink control information (DCI) format that provides:
a trigger for a physical random access channel (PRACH) transmission, and
an indication that a PRACH occasion (RO), for the PRACH transmission, comprises:
a first number of symbols that are in the first symbols and are not in the second symbols, or
a second number of symbols that are in the second symbols; and
a processor operably coupled to the transceiver, the processor configured to determine a first RO based on the indication,
wherein the transceiver is further configured to transmit the PRACH in the first RO.

2. The UE of claim 1, wherein the indication comprises one bit in the DCI format.

3. The UE of claim 1, wherein:
the first information is a configuration of symbols for time division duplex (TDD) operation, and
the first symbols are uplink symbols or flexible symbols in the configuration.

4. The UE of claim 1, wherein:
the first information is a configuration of symbols for time division duplex (TDD) operation, and
the second symbols are downlink symbols or flexible symbols in the configuration.

5. The UE of claim 1, wherein:
the SIB provides third information for a frequency sub-band, and
the transceiver is further configured to:
transmit the PRACH within an active uplink bandwidth part that includes the frequency sub-band when the first RO comprises the first symbols, and
transmit the PRACH within the frequency sub-band when the first RO comprises the second symbols.

6. The UE of claim 1, wherein the transceiver is further configured to transmit a physical uplink shared channel (PUSCH) over one of:
a third number of symbols that are in the first symbols and are not in the second symbols when the first RO comprises the second symbols, or
a fourth number of symbols that are in the second symbols when the first RO comprises the first symbols.

7. The UE of claim 1, wherein the transceiver is further configured to transmit, prior to the reception of the DCI format, an indication for a capability to transmit over symbols that are in the second symbols.

8. A base station (BS) comprising:
a transceiver configured to:
transmit a system information block (SIB) that provides:
first information for first symbols associated only with receptions, and
second information for second symbols associated with transmissions or receptions, and
transmit a downlink control information (DCI) format that provides:
a trigger for a physical random access channel (PRACH) reception, and
an indication that a PRACH occasion (RO), for the PRACH reception, comprises:
a first number of symbols that are in the first symbols and are not in the second symbols, or
a second number of symbols that are in the second symbols; and
a processor operably coupled to the transceiver, the processor configured to determine a first RO based on the indication,
wherein the transceiver is further configured to receive the PRACH in the first RO.

9. The BS of claim 8, wherein the indication comprises one bit in the DCI format.

10. The BS of claim 8, wherein:
the first information is a configuration of symbols for time division duplex (TDD) operation, and
the first symbols are uplink symbols or flexible symbols in the configuration.

11. The BS of claim 8, wherein:
the first information is a configuration of symbols for time division duplex (TDD) operation, and
the second symbols are downlink symbols or flexible symbols in the configuration.

12. The BS of claim 8, wherein:
the SIB provides third information for a frequency sub-band, and
the transceiver is further configured to:
receive the PRACH within an active uplink bandwidth part that includes the frequency sub-band when the first RO comprises the first symbols, and
receive the PRACH within the frequency sub-band when the first RO comprises the second symbols.

13. The BS of claim 8, wherein the transceiver is further configured to receive a physical uplink shared channel (PUSCH) over one of:
a third number of symbols that are in the first symbols and are not in the second symbols when the first RO comprises the second symbols, or
a fourth number of symbols that are in the second symbols when the first RO comprises the first symbols.

14. A method of operating a user equipment (UE), the method comprising:
receiving a system information block (SIB) that provides:
first information for first symbols associated only with transmissions, and
second information for second symbols associated with transmissions or receptions;
receiving a downlink control information (DCI) format that provides:
a trigger for a physical random access channel (PRACH) transmission, and
an indication that a PRACH occasion (RO), for the PRACH transmission, comprises:
a first number of symbols that are in the first symbols and are not in the second symbols, or
a second number of symbols that are in the second symbols;
determining a first RO based on the indication; and
transmitting the PRACH in the first RO.

15. The method of claim 14, wherein the indication comprises one bit in the DCI format.

16. The method of claim 14, wherein:
the first information is a configuration of symbols for time division duplex (TDD) operation, and
the first symbols are uplink symbols or flexible symbols in the configuration.

17. The method of claim 14, wherein:
the first information is a configuration of symbols for time division duplex (TDD) operation, and
the second symbols are downlink symbols or flexible symbols in the configuration.

18. The method of claim 14, further comprising:
transmitting the PRACH within an active uplink bandwidth part that includes a frequency sub-band when the first RO comprises the first symbols, and
transmitting the PRACH within the frequency sub-band when the first RO comprises the second symbols, wherein the SIB provides third information for the frequency sub-band.

19. The method of claim 14, further comprising:
transmitting a physical uplink shared channel (PUSCH) over one of:
a third number of symbols that are in the first symbols and are not in the second symbols when the first RO comprises the second symbols, or
a fourth number of symbols that are in the second symbols when the first RO comprises the first symbols.

20. The method of claim 14, further comprising:
transmitting an indication, prior to the reception of the DCI format, for a capability to transmit over symbols that are in the second symbols.
